(19) United States
(12) Patent Application Publication
(10) Pub. No.: US 2010/0313351 A1
(43) Pub. Date: Dec. 16, 2010

(54) PLUMBING FIXTURE PROTECTOR

(76) Inventor: Donald W. Wooten, Arlington, TX (US)

Correspondence Address: DUNLAP CODDING, P.C., PO BOX 16370, OKLAHOMA CITY, OK, 73113, US

(21) Appl. No.: 12/483,117

(22) Filed: Jun. 11, 2009

(51) Int. Cl. E03D 11/00; B23P 17/04; B32B 3/24

(52) U.S. Cl. 4/420; 29/428; 428/131

(57) ABSTRACT

A toilet bowl protector for protecting a finish of a toilet bowl, the toilet bowl including a bowl portion and a siphon tube disposed at a bottom of the bowl portion, the toilet bowl protector comprising a bowl shaped portion and an extension portion extending from the bowl shaped portion.

### BACKGROUND OF THE INVENTION

1. Field of the Invention

This invention relates to a plumbing fixture protector, and more particularly, but not by way of limitation, to a plumbing fixture protector which operates to protect plumbing fixtures such as toilets from physical damage caused by an auger during the clearing of obstructing debris located within the piping connected to the toilet.

2. Brief Description of Related Art

The use of augers, for example closet augers, is well known in the plumbing arts. While the use of augers is well known, certain problems may arise during their insertion, operation, and/or removal from a plumbing fixture. In general, augers are used to clear obstructing debris from piping. More specifically, augers are commonly used to clear obstructing debris that has accumulated in plumbing pipes connected to plumbing fixtures such as sink drains and toilets. Obstructing debris can collect within the pipe over time and may substantially or even completely prevent the communication of fluid and/or waste products through the pipe.

Common augers consist of a coiled metal wire with an enlarged end portion for engaging the obstructing debris and an opposing end attached to a device, usually a crank that rotates the coiled wire and communicates the coiled wire through the pipe. In most cases, the coiled metal wire is fed through a piece of bent metal tubing shaped to provide access to a siphon tube of the toilet. A plastic boot covering a portion of the metal tubing protects the finish of the visible porcelain. The enlarged end portion is inserted into the bowl and through the siphon tube and the crank is rotated to drive the enlarged end portion through the pipe. Once contact is made with the obstructing debris the crank of the auger is turned to continually rotate the enlarged end portion against the obstructing debris until it passes through the debris or until the obstructing debris is dislodged from the pipe. The enlarged end portion may be removed and reinserted multiple times in order to vary the position of the enlarged end portion with respect to the obstructing debris.

While typical augers provide limited means for protecting the porcelain finish of the toilet bowl, a typical auger cannot provide protection against incidental damage caused by unwanted or accidental contact between the auger and the toilet bowl. Furthermore, do-it-yourself obstruction removal performed by individuals who are not familiar with the proper selection and/or operation of augers may result in the selection of an auger which is not suited for use in toilet bowls such as hand augers (typically used for clearing obstructions from sinks and bathtub drains) which are not provided with any protective covering. The use of such augers can cause costly damage to the porcelain finish of the toilet.

Therefore, a need exists for a plumbing fixture protector, the plumbing fixture protector capable of protecting the porcelain and/or other finish of a plumbing fixture from physical damage due to operation of the auger. It is to such a plumbing fixture protector that the present invention is directed.

### BRIEF DESCRIPTION OF THE DRAWINGS

FIG. 1 is a cross-sectional, side elevational view of a toilet having a plumbing fixture protector disposed therein, in accordance with the present invention.

FIG. 2 is a perspective view of the plumbing fixture protector device of FIG. 1.

FIG. 3A is an exploded, perspective view of another embodiment of a plumbing fixture protector (toilet protector) having separable siphon tube portions and bowl portions.

FIG. 3B is a perspective view of an additional siphon tube portion for use with the plumbing fixture protector of FIG. 3A.

FIG. 4 is a side elevational view of an alternative embodiment of a plumbing fixture protector disposed within and covering a bowl of a toilet, in accordance with the present invention.

### DETAILED DESCRIPTION OF EXEMPLARY EMBODIMENTS

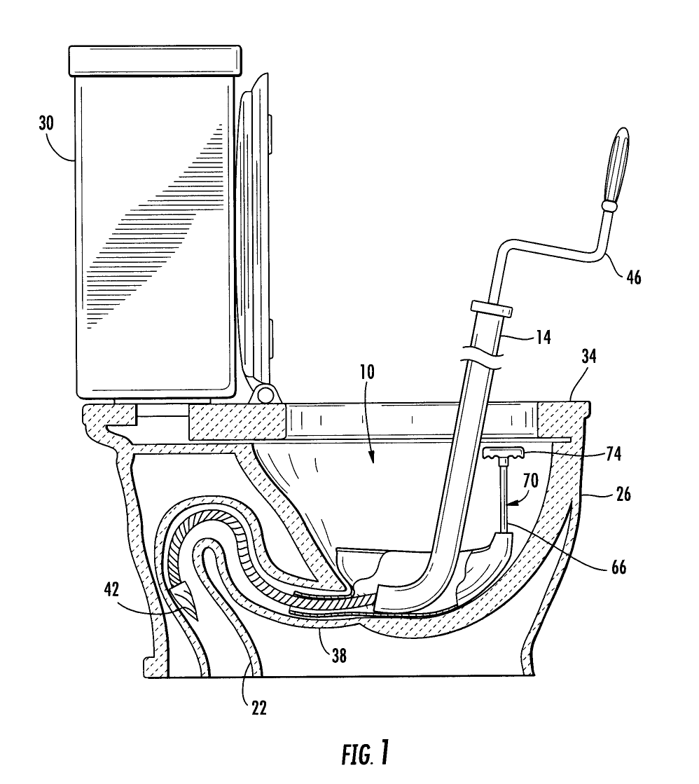

Referring now to the drawings, and more particularly to FIG. 1, shown therein is a side elevational view of a plumbing fixture protector, in this case a toilet protector 10 for use during the insertion, operation, and removal of a plumber's snake or auger 14 to clear obstructing debris from a pipe 22 connected to a portion of a toilet 26. The toilet 26 is provided with a tank 30 and a bowl 34 connected to a siphon tube 38 which is in turn connected to the pipe 22. It will be understood that various parts of the toilet 26 are provided with a glazed porcelain finish that covers the porcelain. The glazed porcelain finish not only protects the hardened material that the toilet 26 is fabricated from but also enhances the aesthetic qualities of the toilet 26. Although the glazed finish is somewhat durable, it is nevertheless somewhat susceptible to scratches or impacts from blunt objects.

The auger 14 is generally provided with a coiled wire with one end having a debris engaging portion 42 and a means for rotating and extending the debris engaging portion 42 through the pipe 22. In one embodiment, the means for rotating the debris engaging portion 42 includes a hand crank 46, although any number of other means for rotating the debris engaging portion 42 that would be known to one of ordinary skill in the art with the present disclosure before them are likewise contemplated for use. The debris engaging portion 42 is inserted into the bowl 34 and through the siphon tube 38 and the hand crank 46 is rotated to drive the debris engaging portion 42 through the pipe 22 until contact is made with the obstructing debris. The crank of the auger 14 is then turned to rotate the debris engaging portion 42 against the obstructing debris until it passes through the debris or until the obstructing debris is dislodged from the pipe 22. It will be understood that when the debris engaging portion 42 of the auger 14 is inserted into the bowl 34 and through the siphon tube 38 of the toilet 26, the debris engaging portion 42 may cause physical damage to the bowl 34 such as scratching of the finish and/or cracking of the porcelain finish.

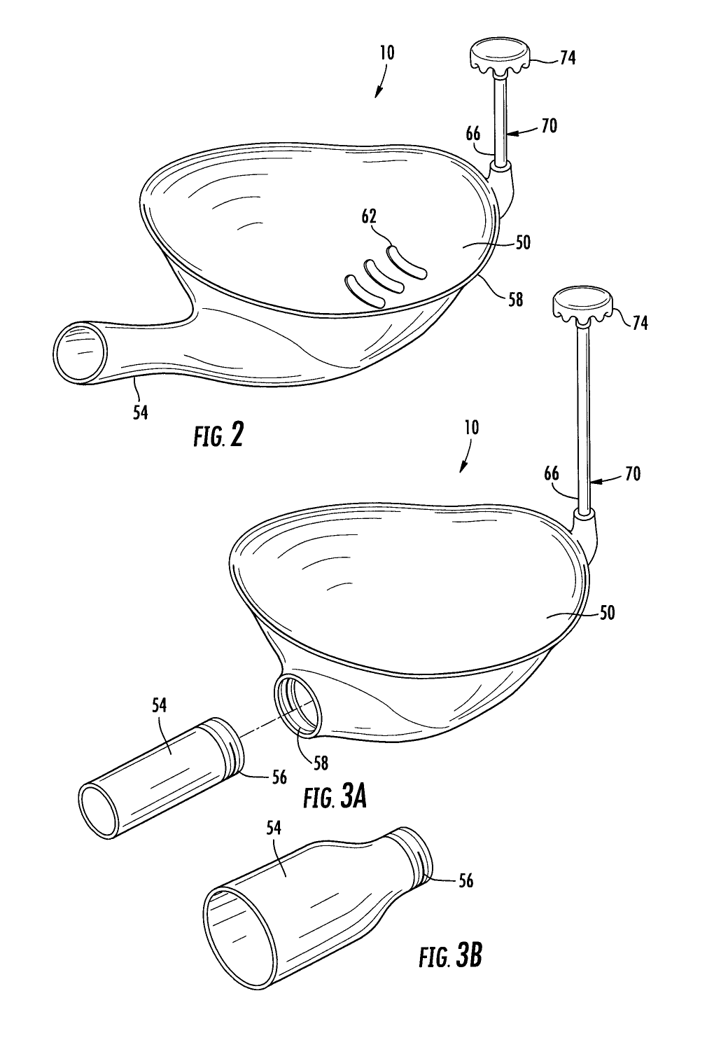

Referring now to FIG. 2, to prevent and/or substantially limit such damage, the toilet 26 is provided with the toilet protector 10. The toilet protector 10 is provided with a bowl shaped portion 50 and an extension portion 54. The toilet protector 10 is constructed of a flexible and/or semi-flexible yet durable material such as a plastic polymer or silicone, although it will be understood that part or all of the toilet protector 10 may be constructed from a rigid or semi-rigid material so long as the material does not scratch or otherwise damage the porcelain finish of the toilet 26. Examples of rigid and/or semi-rigid material include but are not limited to a resin or hard plastic polymer, natural material(s) such as a wood or fiber based material, metal (such as steel, titanium, aluminum or blends thereof), fiber or glass based materials and combinations thereof. It will be understood that if the toilet protector 10 is fabricated from a material which may scratch and/or otherwise damage the toilet 26, the toilet protector 10 may be coated with a protective coating such as a rubber to prevent such potential damage. In one embodiment, the toilet protector 10 is constructed from a flexible material that may at least partially conform to the contours of the inner surface of the bowl 34 and/or the siphon tube 38 of various toilets 26. In another embodiment, the toilet protector 10 is constructed from a rigid or semi-rigid material and the toilet protector 10 is shaped to substantially conform to a specific type of toilet 26, for example as specific manufacturer.

The bowl shaped portion 50 is preferably sized to fit within the lower portion of the bowl 34 of the toilet 26 to cover and protect the same against potential physical damage caused by the insertion, operation, and/or removal of the auger 14. It will be understood that the bowl shaped portion 50 is sized to conform to the bowl 34 of the toilet 26, the bowl shaped portion 50 may also include different shapes and sizes, for example, elliptical, although any number of different geometric (e.g., triangular, octagonal, circular, polygonal) or non-geometric shapes (e.g., star-shaped, kidney shaped or animal shapes) that would be know to one or ordinary skill in the art with the present disclosure before them are likewise contemplated for use in accordance with the present invention. The bowl shaped portion 50 may include an outwardly flaring upper edge 58 that substantially conforms to the shape of the bowl 34 and provides support to the toilet protector 10. It will be understood that in additional embodiments, the outwardly flaring upper edge 58 may not substantially conform to the shape of the bowl 34 of the toilet 26. The extension portion 54 of the toilet protector 10 preferably extends from a lower region of the bowl shaped portion 50. The extension portion 54 may have a substantially tubular cross-sectional area that is sized to fit within the siphon tube 28 of the toilet 26 such that the extension portion 54 may be inserted into the siphon tube 28 to protect the porcelain finish of the siphon tube 28 from physical damage. Although the extension portion 54 has been disclosed as being substantially tubular, the extension portion 54 may also be semi-circular, substantially c-shaped, substantially v-shaped, or even irregularly shaped. It will be understood that the extension portion 54 may or may not contact at least a portion of the siphon tube 28 when the extension portion 54 is disposed within the siphon tube 28.

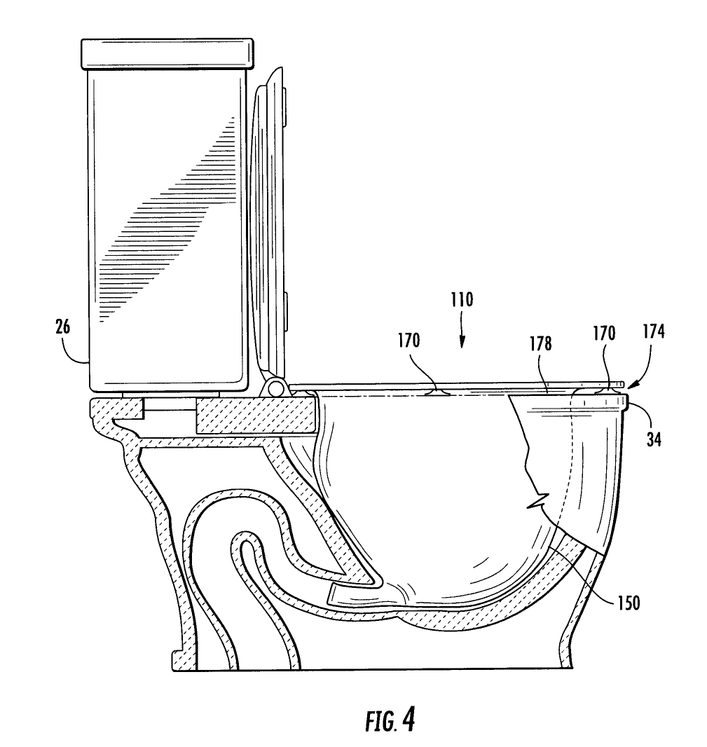

Referring now to FIGS. 3A and 3B collectively, in one embodiment, the bowl shaped portion 50 and the extension portion 54 of the toilet protector 10 may be fabricated as a unitary member or may be separate components such that either the bowl shaped portion 50 and/or the extension portion 54 may be interchanged to accommodate different sized and/or shaped toilets 26. For example, two different toilets 26 may have similarly sized bowls 26 but have different diameter siphon tubes 38. If the extension portion 54 and the bowl shaped portion 50 are fabricated separately, the extension portion 54 may be removed and replaced with an extension portion 54 having a diameter that more closely corresponds to each of the siphon tubes 38 of the toilets 26. The extension portions 54 and the bowl shaped portions 50 may be joined together for example by providing matching threaded portions 56 and 58 on the extension portions 54 and the bowl shaped portions 50, respectively. Additional examples of connections between extension portions 54 and the bowl shaped portions 50 include, but are not limited to, compression fittings, fasteners, adhesives and the like.

In some instances, the toilet 26 may include one or more water jets or nozzles (not shown) disposed within the bowl 34 of the toilet 26 which operate to drive debris located in the bowl 34 of the toilet 26 into the siphon tube 38 and into the pipe 22. Therefore, the bowl shaped portion 50 of the toilet protector 10 may also include one or more apertures 62 providing fluid communication between one or more water jets or nozzles of the toilet 26 and the siphon tube 38 of the toilet 26. The operation of the one or more water jets or nozzles during operation of the auger 14 may assist in the removal of the obstructing debris from the pipe 22.

Additionally, the toilet protector 10 may include a handle 66 (see FIG. 1) extending from the bowl shaped portion 50 to provide a more sanitary means for the insertion and removal of the toilet protector 10. The handle 66 may include an elongated member 70 and grasping portion 74. The elongated member 70 is preferably connected, either releaseably or fixedly, to at least a portion of the bowl shaped portion 50 of the toilet protector 10. The grasping portion 74 may include any number of components designed to allow a user to grip the grasping portion 74 and control the placement of the toilet protector 10 within the bowl 34 of the toilet 26. Non-limiting examples of grasping portion include a knob, a ring, or any other devices for grasping that would be known to one of ordinary skill in the art with the present disclosure before them.

In operation, the toilet protector 10 is placed within the bowl 34 of the toilet 26 prior to the insertion or operation of the auger 14. The toilet protector 10 is utilized by using the grasping portion 74 of the handle 66 to maneuver the toilet protector 10 into the bowl 34 of the toilet 26. The extension portion 54 of the toilet protector 10 is inserted into the siphon tube 38 of the toilet 26 and then the bowl shaped portion 50 of the toilet protector 10 is seated within the bowl 34 of the toilet 26. Next, the debris engaging portion 42 of the auger 14 is inserted though the passage defined by the bowl shaped portion 50 and the extension portion 54 of toilet protector 10 and into the siphon tube 38 of the toilet 26. The auger 14 is operated to communicate the debris engaging portion 42 of the auger 14 through the siphon tube 38 and the pipe 22 until the debris engaging portion 42 of the auger 14 contacts the obstructing debris. The operation of the auger 14 is continued, rotating the debris engaging portion 42 until the obstructing debris is cleared from the pipe 22. It will be understood that the debris engaging portion 42 of the auger 14 may need to be removed and reinserted into the pipe 22 numerous times to remove the obstructing debris.

Referring now to FIG. 4, in another embodiment, a toilet protector 110 is constructed similarly to the toilet protector 10 described above with the exception that the bowl shaped portion 150 is large enough to cover the entire bowl 34 of the toilet 26. Furthermore, the bowl shaped portion 150 may include one or more securement members 170 disposed along the top edge 174 of the bowl shaped portion 150 for releaseably securing the bowl shaped portion 150 to at least a portion of the toilet 26, for example, the top rim 178 of the bowl 34. Examples of securement members 170 include, but are not limited to, suction cups, hook and loop fasteners, adhesives, and the like. It will be understood that a portion of the bowl shaped portion 150 may rest upon the top rim 178 of the bowl 34 rather than secure to the top rim 178. This embodiment of the toilet protector 110 functions to protect the entire inside of the bowl 34 from potential damage resulting from the operation of the auger 14.

Changes may be made in the construction and the operation of the various components, elements and assemblies described herein or in the steps or the sequence of steps of the methods described herein without departing from the spirit and scope of the invention.

What is claimed is:

1. A toilet bowl protector for protecting a finish of a toilet bowl, the toilet bowl including a bowl portion and a siphon tube disposed at a bottom of the bowl portion, the toilet bowl protector comprising:
a bowl shaped portion, the bowl shaped portion configured to conform to at least a portion of the bowl portion of the toilet; and
an extension portion extending from the bowl shaped portion in such a way that the extension portion is disposable within the siphon tube of the toilet when the bowl shaped portion is positioned in the bowl portion of the toilet so that the bowl shaped portion and the extension portion cooperate to define a passage sized to receive a plumber's snake and to protect the finish of the toilet bowl from physical damage due to contact between the plumber's snake and the toilet bowl.

2. The protector of claim 1, wherein the bowl shaped portion is sized to cover the entire bowl portion of the toilet and contact a rim of the toilet.

3. The protector of claim 1, wherein the extension portion is substantially tubular.

4. The protector of claim 1, wherein the bowl shaped portion and the extension portion are releaseably secured together such that at least one of the bowl shaped portion and the extension portion may be removed and replaced.

5. The protector of claim 1, wherein the toilet bowl shaped portion has at least one aperture opposite the extension portion so as to provide fluid communication between a water jet of the toilet and the siphon tube of the toilet.

6. The protector of claim 1, wherein at least a portion of the toilet bowl protector is fabricated from a flexible material such that at least a portion of the toilet bowl protector may conform to an inner surface of the toilet bowl.

7. A toilet bowl protector in combination with a toilet bowl for protecting a finish of the toilet bowl, the toilet bowl including a bowl portion and a siphon tube disposed at a bottom of the bowl portion, the toilet bowl protector comprising:
a bowl shaped portion, the bowl shaped portion conforming to at least a portion of the bowl portion of the toilet; and
an extension portion extending from the bowl shaped portion in such a way that the extension portion is disposed within the siphon tube of the toilet, the bowl shaped portion and the extension portion cooperating to define a passage sized to receive a plumber's snake and to protect the finish of the toilet bowl from physical damage due to contact between the plumber's snake and the toilet bowl.

8. The combination of claim 7, wherein the bowl shaped portion is sized to cover the entire bowl portion of the toilet and contact a rim of the toilet.

9. The combination of claim 7, wherein the extension portion is substantially tubular.

10. The combination of claim 7, wherein the bowl shaped portion and the extension portion are releaseably secured together such that at least one of the bowl shaped portion and the extension portion may be removed and replaced.

11. The combination of claim 7, wherein the toilet bowl shaped portion has at least one aperture opposite the extension portion so as to provide fluid communication between a water jet of the toilet and the siphon tube of the toilet.

12. The combination of claim 7, wherein at least a portion of the toilet bowl protector is fabricated from a flexible material such that at least a portion of the toilet bowl protector may conform to an inner surface of the toilet bowl.

13. A method of protecting at least a portion of a toilet bowl, the toilet bowl including a bowl portion and a siphon tube disposed at a bottom of the bowl portion, the method comprising the steps of:
lining at least a portion of the siphon tube of the toilet;
lining at least a portion of the bowl portion of the toilet; and
inserting at least a portion of an object into the toilet, the object contacting the lining of the siphon tube and the bowl portion of the toilet rather than the siphon tube and the bowl portion of the toilet to protect the same against physical damage due to contact between the object and the toilet bowl.

14. The method of claim 13, wherein the steps of lining the siphon tube and the bowl portion further include the step of inserting a toilet bowl protector into the toilet bowl, the toilet bowl protector comprising:
a bowl shaped portion, the bowl shaped portion conforming to at least a portion of the bowl portion of the toilet; and
an extension portion extending from the bowl shaped portion in such a way that the extension portion is disposed within the siphon tube of the toilet, the bowl shaped portion and the extension portion cooperating to define a passage sized to receive a plumber's snake and to protect the finish of the toilet bowl from physical damage due to contact between the plumber's snake and the toilet bowl.

15. The method of claim 14, wherein in the step of inserting the toilet bowl protector within the toilet bowl, the step further includes inserting the extension portion of the toilet bowl protector into the siphon tube of the toilet bowl and contacting at least a portion of the bowl shaped portion to the bowl portion of the toilet bowl.

16. The method of claim 13, wherein the bowl shaped portion is sized to cover the entire bowl portion of the toilet and contact a rim of the toilet.

17. The method of claim 13, wherein the extension portion is substantially tubular.

18. The method of claim 13, wherein the bowl shaped portion and the extension portion are releaseably secured together such that at least one of the bowl shaped portion and the extension portion may be removed and replaced.

19. The method of claim 13, wherein the toilet bowl shaped portion has at least one aperture opposite the extension portion so as to provide fluid communication between a water jet of the toilet and the siphon tube of the toilet.

20. The method of claim 19, further comprising the step of activating the water jet of the toilet to communicate water through the one or more apertures of the toilet bowl protector into the siphon tube of the toilet bowl.

21. The method of claim 13, wherein at least a portion of the toilet bowl protector is fabricated from a flexible material such that at least a portion of the toilet bowl protector may conform to an inner surface of the toilet bowl.

22. The method of claim 13, wherein the object is selected from a group consisting of: a plumber's snake, a hand auger, a powered auger, a closet auger, or combinations thereof.
